(19) United States
(12) Patent Application Publication
(10) Pub. No.: US 2010/0315503 A1
(43) Pub. Date: Dec. 16, 2010

(54) Digital microscope device

(76) Inventor: James Chen, Hsichih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,562

(22) Filed: Jun. 16, 2009

(51) Int. Cl. H04N 7/18

(52) U.S. Cl. 348/80; 348/E07.085

(57) ABSTRACT

The present invention relates to a digital microscope device that is mainly an innovative electronic equipment for observing, inspecting, and recording minute structures. It is including a digital microscope body set with a LCD on its top, and set with an optical lens and a main electrical circuit board in the main body. By utilizing the main electrical circuit board to link with the optical lens and LCD to display the images inspected by the optical lens directly on a LCD, a portable digital microscope that can be carried to any locations is formed, is convenient for the observation of users, and can store the observed images directly to obtain the better effectiveness.

### FIELD OF THE INVENTION

The present invention is related to an improvement design of microscope used for inspecting the structures of minute goods. By utilizing an optical lens and cooperating with the digital technology, a portable digital microscope which can be carried to any locations and itself set with a LCD (liquid crystal display) is formed.

### PRIOR ART OF THE INVENTION

An ordinary microscope carries out the inspections on structures of some minute goods by using a direct visual method to aim at the optical lens. It is not convenient while being used and not easily aligned, and the image obtained is also unable to be stored for future further usage. This is very regretful. It is known to have another way to do the observation by using the PCCAM device; however, its inspecting images need to be operated through the display of computer and unable to be used independently. Therefore, it is also causing the inconvenience while be used and waited to be improved.

### SUMMARY OF THE INVENTION

The object of present invention is to provide a digital microscope device that is mainly an innovative electronic equipment for observing, inspecting and recording minute structures. Through an optical lens of the digital microscope to inspect the images and display them directly on a LCD, it is a portable digital microscope that can be carried to any locations, is convenient for the observation of users, and can store the observed images directly to obtain the progressiveness. Now, by cooperating with the drawings, the characteristics and effectiveness of present invention are described as following.

### BRIEF DESCRIPTION OF THE DRAWINGS

FIGS. 1 and 2 are outside appearance diagrams according to the present invention.

FIG. 3 is a sectional diagram in the front view of present invention.

FIG. 4 is a sectional diagram in the side view of present invention.

### DETAILED DESCRIPTION OF THE PREFERRED EMBODIMENT

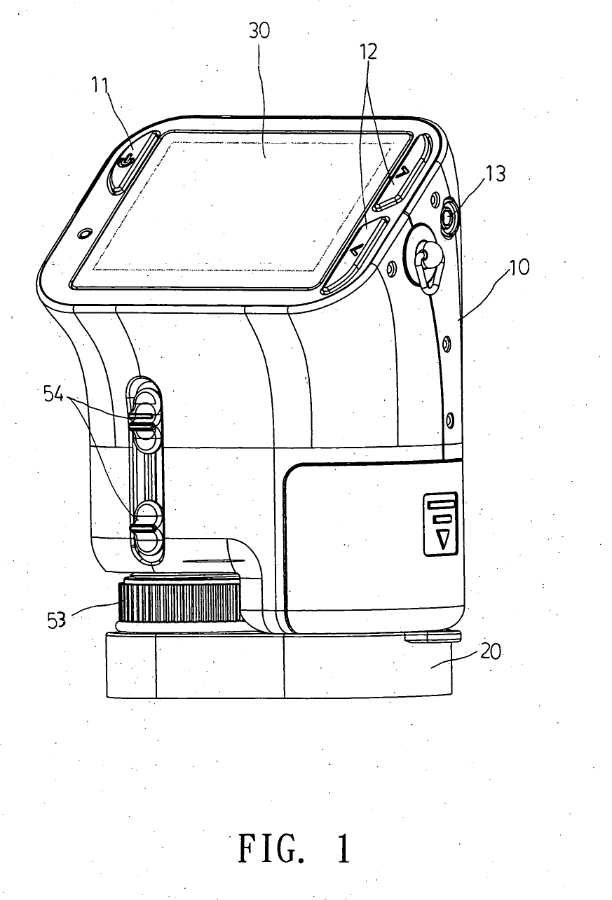

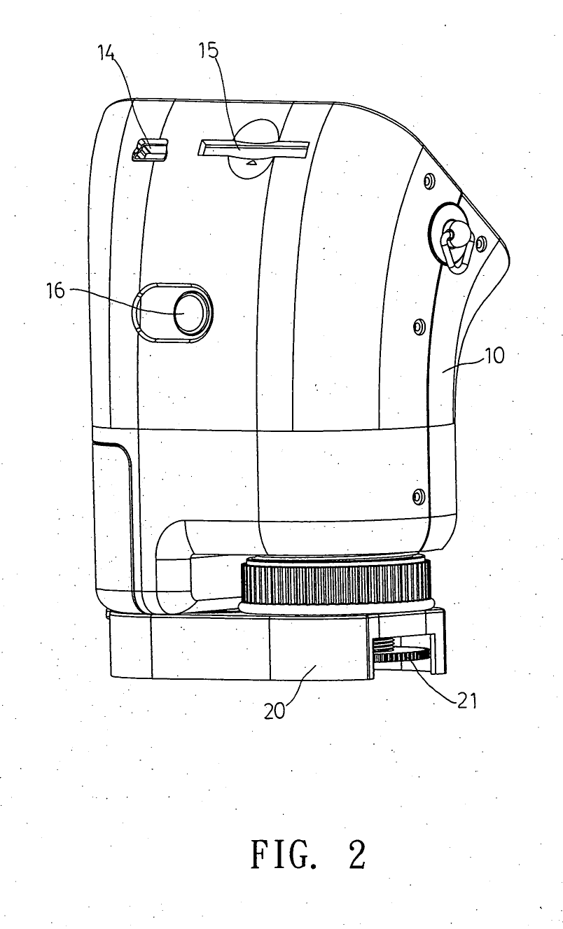

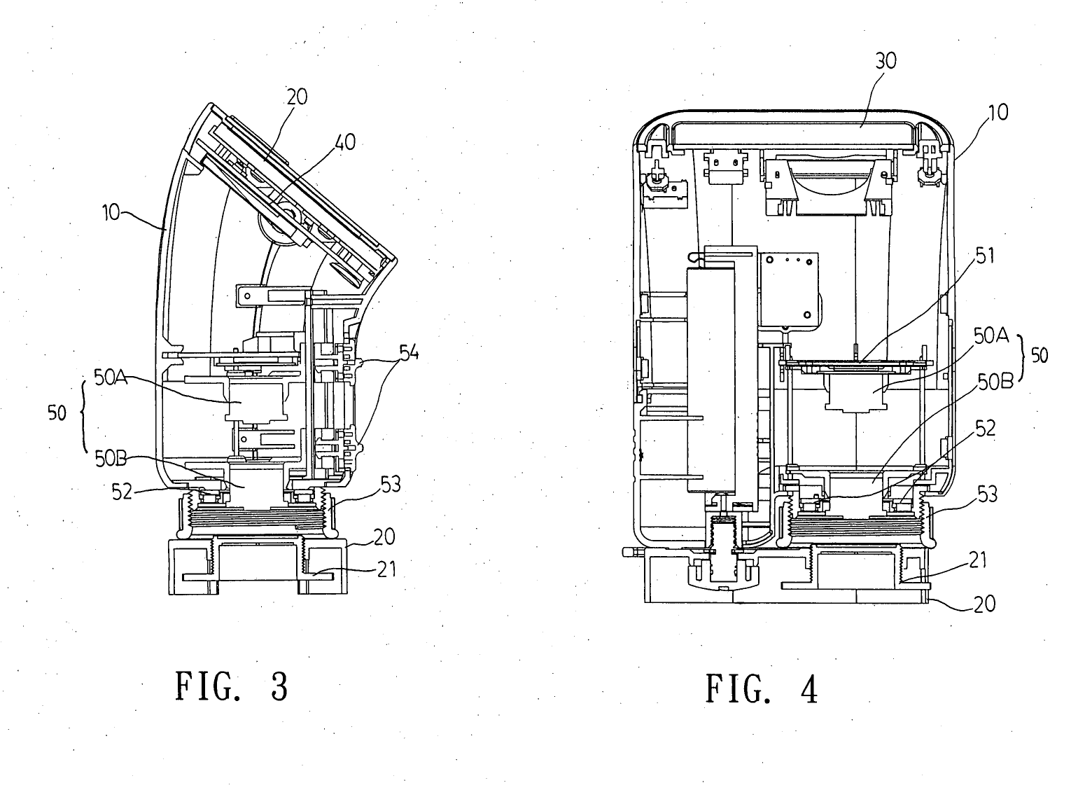

Please refer to those shown in FIGS. 1 to 4. The present invention is an improved digital microscope device that is mainly including a microscope body 10 and is capable of connecting with an observing auxiliary 20. The main body 10 has a LCD 30 set on top of it. A main electrical circuit board 40 is connect-set in the bottom of LCD 30; and a power key 11 and the function keys 12 are separately set on two sides of LCD 30. The main body 10 is set with a TV inserting socket in its one side. Furthermore, the main body 10 is set with an USB inserting socket 14, a SD-card inserting slot 15, and a picture-taking key 16 in its rear side. And, the main body 10 has an optical lens assembly 50 set in it with a set of image sensor 51 set on top portion 50A and with the LED light sources 52 set in the perimeter of lower portion 50B. And, an out-exposed focus adjusting knob 53 is connect-set in the bottom of main body 10. Furthermore, focus adjusting keys 54 are separately set at the locations on the front side of main body 10 relative to the optical lens assembly 50. The main body 10 is further assemble-set with the battery in it to supply the required power. The said auxiliary 20 is capably connect-set in the bottom of the main body 10, and has an observing auxiliary focus adjusting knob 21 set under the optical lens assembly 50.

While being used, the main elements of present invention are. While carrying out the experimental inspection, the inspected object is firstly put at the site of the microscope body 10 in the bottom such that the inspected object can be just located right under the optical lens assembly 50 of main body 10. Then the power key 11 is pressed to activate the battery power to start the operation of main electrical circuit board 40. Simultaneously, the LED light source 52 is lightened such that the inspected object can receive the light, and the inspected images will be displayed on the LCD 30 through the optical lens assembly 50 and image sensor 51. Furthermore, the focus adjusting key 54 can be utilized to carry out the focus adjustment for the optical lens assembly 50 for that a multiple staged optical enlargement ratio is carried out or a digitalized enlargement is utilized through these to get the optimum inspected images. And a further step of minute adjustment in the focus can be carried out by utilizing the focus adjusting knob 53. In another embodiment when connecting with the auxiliary 20, an observing auxiliary focus adjusting knob 21 on the auxiliary 20 can also be utilized to carry out the minute focus adjustment of inspected object in detail.

Furthermore, the picture-taking key 16 can be utilized to carry out the picture-taking of inspected images and save them in the main electrical circuit board 40 through the function keys. The inspected images can also be displayed on large sized TV screen by connect-setting the conductive wire to the TV socket 13. Or, the inspected images can saved in the USB or SD cards by utilizing the USB inserting socket 14 and SD card inserting slot 15. Through this kind of design, the said digital microscope can directly display the images inspected by the optical lens on the LCD of main body without the requirement of displaying images through the computers, and it is a portable digital microscope that can be carried to any locations and is equipped with practicality and progressiveness.

However, the aforementioned is only a better implementing example of the present invention. All other embellishment or modification shall be all included within the scope of the present patent.

I claim:

1. A digital microscope device including a microscope body, which has a LCD set on top of it with a main electrical circuit board connect-set in the bottom of LCD and with a power key and the function keys are separately set on two sides of LCD, and the main body has an optical lens assembly set in it with a set of image sensor set on top portion and with the LED light sources set in the perimeter of lower portion, and the main body is connect-set with an out-exposed focus adjusting knob in the bottom of it, the integral body can directly display the observed images on the LCD or the pictures is photo-taken and stored, it is a portable digital microscope being capably carried to any locations.

2. A digital microscope device according to the claim 1, wherein the main body is capably connect-set in the bottom with an auxiliary, having an observing auxiliary focus adjusting knob set at the lower site.

3. A digital microscope device according to the claim 1, wherein the main body is set with a TV inserting socket in its one side.

4. A digital microscope device according to the claim 1, wherein the main body is set with an USB, inserting socket, a SD-card inserting slot and a picture-taking key in its rear side.

5. A digital microscope device according to the claim 1, wherein the main body is assemble-set with the battery in it to supply the required power.
